(19) United States
(12) Patent Application Publication
(10) Pub. No.: US 2011/0025724 A1
(43) Pub. Date: Feb. 3, 2011

(54) BACKLIGHT UNIT AND DISPLAY APPARATUS INCLUDING THE SAME

(75) Inventors: Hoon Hur, Pyeongtaek-si (KR); Bup Sung Jung, Pyeongtaek-si (KR)

Correspondence Address: KED & ASSOCIATES, LLP, P.O. Box 8638, Reston, VA, 20195, US

(73) Assignee: LG Electronics Inc., Seoul (KR)

(21) Appl. No.: 12/728,065

(22) Filed: Mar. 19, 2010

Related U.S. Application Data
(60) Provisional application No. 61/229,854, filed on Jul. 30, 2009.

(30) Foreign Application Priority Data
Aug. 6, 2009 (KR) 10-2009-0072449

(51) Int. Cl. G09G 5/10; G02F 1/13357

(52) U.S. Cl. 345/690; 362/97.1

(57) ABSTRACT

A backlight unit includes at least one light source emitting light in a first direction at a predetermined orientation angle and a plurality of light guide panels, each including a light incident section and a light emitting section. The light incident section has a first surface to receive the light emitted from the light source in the first direction, and the light emitting section is to emit light received from the light incident section in a second direction. At least one portion of the light emitting section of one light guide panel overlaps an upper side of a light incident section of another light guide panel and a space exists between the panels.

### CROSS-REFERENCE TO RELATED APPLICATIONS

The present application claims priority under 35 U.S.C. §119 and 35 U.S.C. §365 to U.S. Provisional Patent Application Ser. No. 61/229,854 filed on Jul. 30, 2009 and Korean Patent Application No. 10-2009-0072449, filed on Aug. 6, 2009, which are hereby incorporated by reference in their entirety.

### BACKGROUND

1. Field

One or more embodiments described herein relate to illumination systems.

2. Background

As our information society develops, needs for diverse forms of display apparatuses are increasing. Accordingly, research has been carried out on various display apparatuses such as liquid crystal display devices (LCDs), plasma display panels (PDPs), electro luminescent displays (ELDs), and vacuum fluorescent displays (VFDs), which have been commercialized.

Of these, an LCD has a liquid crystal panel that includes a liquid crystal layer, a thin film transistor (TFT) substrate, and a color filter substrate facing the TFT substrate with the liquid crystal layer therebetween. Such a liquid crystal panel, having no light source, uses light provided by a backlight unit to display an image.

### BRIEF DESCRIPTION OF THE DRAWINGS

FIG. 1 is diagram showing an embodiment of a display apparatus.

FIG. 2 is a diagram showing a cross-sectional view of a display module that may be included in the display apparatus of FIG. 1.

FIG. 3 is a diagram showing one embodiment of a backlight unit that may be included in the display apparatus of FIG. 1.

FIG. 4 is a diagram showing a dark-line or bright-line effect that may occur on a display screen.

FIG. 5 is a diagram showing another embodiment of a backlight unit.

FIG. 6 is a diagram showing a cross-sectional view of one or more of the aforementioned embodiments of the backlight unit.

FIG. 7 is a diagram showing an exploded view of a light guide panel that may be included in any one of the aforementioned embodiments.

FIG. 8 shows controlling elements for a display apparatus according to an embodiment.

FIG. 9 shows controlling elements for a back light unit according to an embodiment.

FIG. 10 is a perspective view illustrating a reflecting element and a substrate according to an embodiment.

FIG. 11 is a perspective view illustrating a backlight unit according to an embodiment.

FIG. 12 is a plan view of a rear surface of a bottom cover of FIG. 11.

FIG. 13 is a perspective view of a substrate according to an embodiment.

FIG. 14 is a perspective view of a rear surface of the substrate of FIG. 13.

FIG. 15 is an exploded perspective view of an optical assembly according to an embodiment.

FIG. 16 is a perspective view of two light guide panels that are aligned of FIG. 15.

### DETAILED DESCRIPTION

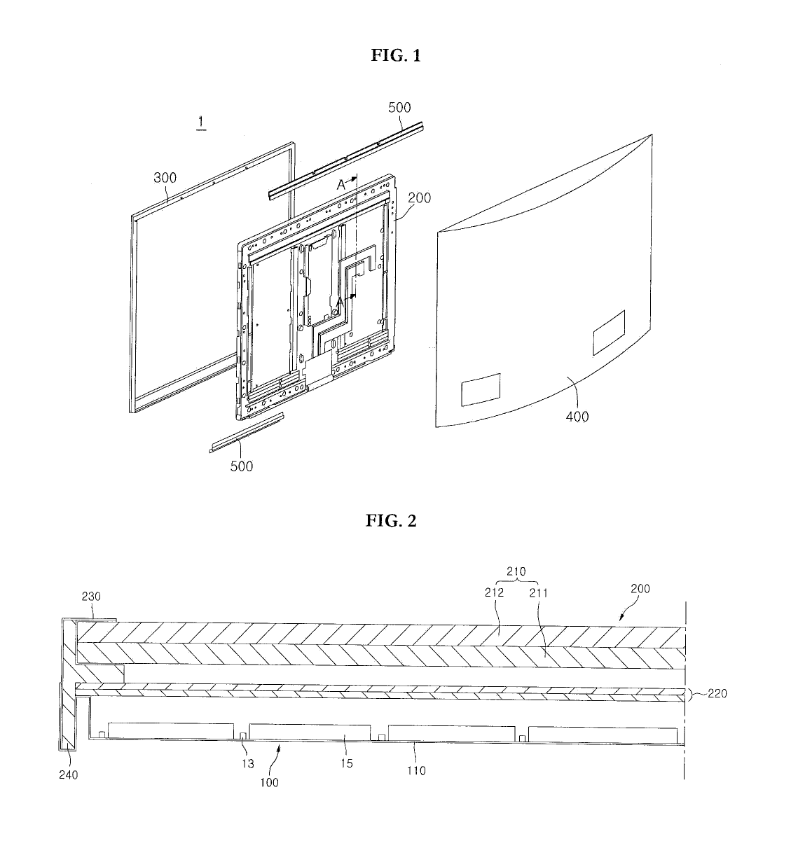

FIG. 1 shows a display apparatus 1 according to an embodiment. Referring to FIG. 1, the display apparatus 1 includes a display module 200, a front cover 300 and a back cover 400 that surround the display module 200, and a fixing member 500 for fixing the display module 200 to at least one of the front cover 300 and the back cover 400.

A portion of the fixing member 500 is fixed to the front cover 300 through a coupling member such as a screw, and then, another portion of the fixing member 500 supports the display module 200 with respect to the front cover 300, so that the display module 200 can be fixed with respect to the front cover 300.

Although the fixing member 500 has an elongated plate shape in the current embodiment, the display module 200 may be fixed to the front cover 300 or the back cover 400 through a coupling member without the fixing member 500.

FIG. 2 is a cross-sectional view taken along line A-A of FIG. 1. Referring to FIG. 2, the display module 200 includes a display panel 210 for displaying an image, a backlight unit 100 emitting light to the display panel 210, a bottom cover 110 providing the lower appearance of the display module 200, a panel supporter 240 supporting the display panel 210 from the lower side, a top cover 230 supporting the display panel 210 from the upper side and constituting a border of the display module 200.

The bottom cover 110 may have a box shape with an open upper surface to receive the backlight unit 100. A side of the bottom cover may be fixed to a side of the top cover 230. For example, a coupling member such as a screw may pass through a side surface of display module 200, that is, through a side where bottom cover 110 overlaps top cover 230 to fix the bottom cover and the top cover.

For example, the display panel 210 may include a lower substrate 211 and an upper substrate 212 attached to each other with a constant cell gap, and a liquid crystal layer interposed between the lower substrate 211 and the upper substrate 212. The lower substrate 211 is provided with a plurality of gate lines and a plurality of data lines crossing the gate lines. Thin film transistors (TFTs) may be disposed in crossing areas of the gate lines and the data lines.

The upper substrate 212 may be provided with color filters, but the structure of the display panel 210 is not limited thereto. For example, the lower substrate 211 may include color filters as well as TFTs. In addition, the structure of the display panel 210 may be varied according to a method of driving the liquid crystal layer.

Although not shown, an edge of the display panel 210 may be provided with a gate driving printed circuit board (PCB) supplying scan signals to the gate lines, and a data driving PCB supplying data signals to the data lines. One of the upper and lower sides of the display panel 210 may be provided with a polarized light filter (not shown).

An optical sheet 220 may be between display panel 210 and backlight unit 100, or optical sheet 220 may be removed. The present disclosure is not limited thereto. The optical sheet may include at least one of a spread sheet and a prism sheet (neither shown).

The spread sheet uniformly spreads light emitted from a light guide panel, and the spread light may be collected to the display panel 210 through the prism sheet. The prism sheet including one or more illumination enhancement films and at least one of a horizontal prism sheet and a vertical prism sheet may be selectively provided. The types and number of optical sheets may be varied within the scope of the present disclosure.

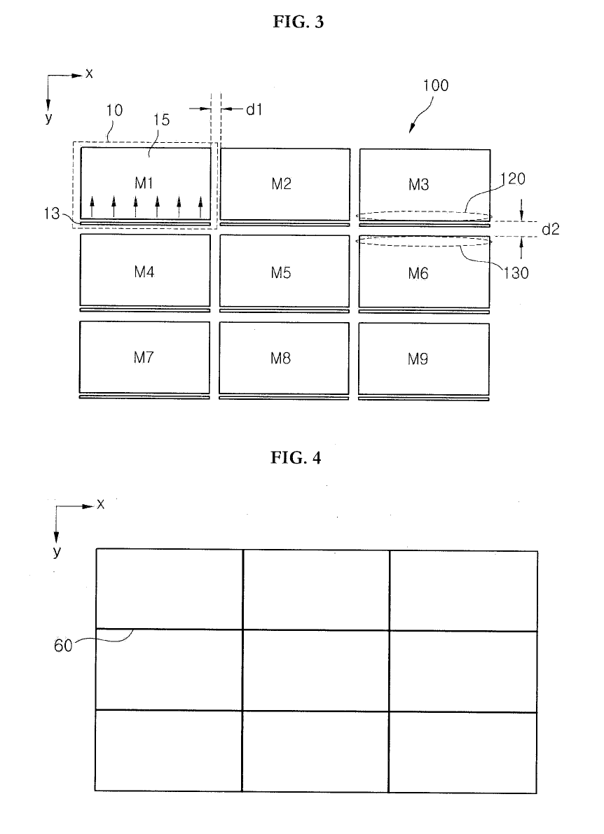

The backlight unit 100 may include a plurality of optical assemblies 10 (refer to FIG. 3), each of which may include a light source 13 and a light guide panel 15.

The light source 13 is disposed on a side of the light guide panel 15 to emit light to the side of the light guide panel 15. For example, the light source 13 may emit light with a predetermined orientation angle with respect to a specific direction in which a light emitting surface of the light source 13 is oriented.

According to the current embodiment, the light source 13 may include one or more light emitting diodes (LEDs). For example, the light source 13 including an LED may emit light with a predetermined orientation angle of about 120° with respect to a direction in which the light emitting surface is oriented.

The LED may be a side illumination-type LED, and be a color LED emitting at least one of red, blue, and green light, or a white LED. The color LED may include at least one of a red LED, a blue LED, and a green LED, and the arrangement and light type of the LEDs may be varied within the scope of the present disclosure.

The light guide panel 15 may be transparent. For example, the light guide panel 15 may be formed of one of acryl-based resin such as polymethyl metaacrylate (PMMA), polyethylene terephthlate (PET), poly carbonate (PC), and polyethylene naphthalate (PEN). The light guide panel 15 may be formed using an extrusion molding method.

The light guide panel 15 may refract and diffuse light, laterally emitted from the light source 13, in the upper direction, that is, to the display panel 210. A reflecting member (not shown) may be disposed under the light guide panel 15.

The light source 13 and the light guide panel 15 are illustrated in FIG. 2 on the basis of their functions, but the shape, coupling structure and relative position of the light source 13 and the light guide panel may be varied within the scope of the present disclosure.

For example, the adjacent light guide panels 15 may partially overlap each other, and decrease in thickness in a predetermined direction.

The backlight unit 100 may be divided into a plurality of blocks, and dividedly driven in a block unit. That is, a plurality of blocks constituting the backlight unit 100 respectively emit streaks of light having different brightness from each other. To this end, the blocks independently receive driving voltages and operate.

For example, the display panel 210 may have a plurality of division areas. The intensity of light emitted from a block of the backlight unit 100, that is, the brightness of the corresponding light source is adjusted according to a gray peak value or a color coordinate signal of the corresponding division area, so as to adjust the brightness of the display panel 210.

FIG. 3 is a plan view illustrating the front side of the backlight unit 100. Referring to FIG. 3, the optical assemblies 10 of the backlight unit 100 may be arrayed in an N×M matrix (N is the number of rows arrayed along a y-axis direction, M is the number of columns arrayed along an x-axis direction, and M and N are natural numbers equal to 2 or greater). Each of the optical assemblies 10 may include the light source 13 and the light guide panel 15.

The light source 13 may emit light with a predetermined orientation angle, e.g. with an orientation angle of about 120° with respect to a first direction (denoted by an arrow), that is, with respect to a parallel direction to a y-axis. Light emitted from the light source 13 is laterally incident to the lower end of the light guide panel 15 and then may travel to the upper end of the light guide panel 15.

The backlight unit 100 may include the light guide panels 15 in the N rows arrayed in the first direction in which the light is emitted, that is, in the y-axis direction, and the light guide panels 15 in the M columns arrayed in the perpendicular direction to the first direction, that is, in the x-axis direction.

That is, as illustrated in FIG. 3, the backlight unit 100 may include the nine light guide panels 15 (M1 to M9) that are the light guide panel 15 in three rows in the first direction and the light guide panels 15 in three columns arrayed in the perpendicular direction to the first direction.

Each of the optical assemblies 10 is driven in an edge-type backlight manner and operates as a single light source. In this state, the optical assemblies 10 are arrayed in a direct-type backlight manner to constitute the backlight unit 100. Thus, the case that the LEDs are detected as a hot spot on a screen can be prevented, and the thickness of the light guide panel 15 and the number of optical films can be reduced to achieve the slimness of the backlight unit 100.

For example, the backlight unit 100 may include the nine optical assemblies 10 (M1 to M9) in a 3×3 matrix as illustrated in FIG. 3, but the present disclosure is not limited thereto. Thus, the matrix of the optical assemblies 10 can be varied according to a screen size of a display apparatus.

Each of the optical assemblies 10 may be manufactured as a discrete assembly, and the optical assemblies 10 may be adjacent to each other to constitute a module-type backlight unit that is a backlight member configured to provide light to the display panel 210.

The backlight unit 100 may be driven using an entire driving method or a local driving method such as a local dimming method and an impulsive method. The method of driving the LEDs may be varied according to a circuit design, and thus is not limited. According to the embodiment, a color contrast ratio is increased, and a bright region and a dark region can be sharply expressed on a screen, thereby improving image quality.

That is, the backlight unit 100 is operated by a plurality of division driving areas corresponding to the light guide panels 15, and the brightness of the division driving area is linked with brightness corresponding to an image signal. Thus, the brightness in a dark portion of an image is decreased, and the brightness in a bright portion of the image is increased, so as to improve a contrast ratio and sharpness of the image.

For example, a portion of the optical assemblies 10 (M1 to M9) is independently driven to emit light. To this end, the light sources 13 respectively of the optical assemblies 10 may be independently controlled.

An area of the display panel 210 corresponding to one of the optical assemblies 10 or one of the light guide panels 15 may be divided into two or more blocks, and the display panel 210 and the backlight unit 100 may be dividedly driven in a block unit.

As illustrated in FIG. 3, the adjacent optical assemblies 10 may be spaced predetermined distances d1 and d2 from each other. For example, the light guide panels 15 adjacent in the perpendicular direction to the first direction (denoted by the arrow) in which light is emitted from the light source 13, that is, in the x-axis direction may be spaced the distance d1 from each other.

The light guide panels 15 adjacent in the first direction, that is, in the y-axis direction may be spaced the distance d2 from each other. That is, when the number of rows of the light guide panels 15 arrayed in the first direction in which light is emitted is N as described above, a K^{th} one (K is one of 1 to N−1) of the N light guide panels 15 arrayed in the first direction may be spaced the distance d2 from an adjacent K+1^{th} one.

When the number of columns of the light guide panels 15 arrayed in the perpendicular direction to the first direction is M, an L^{th} one (L is one of 1 to M−1) of the M light guide panels 15 arrayed in the perpendicular direction to the first direction may be spaced the distance d1 from an adjacent L+^{th} one.

The distances d1 and d2 may cause bright lines or dark lines on the optical assemblies 10, and particularly, on boundaries between the adjacent light guide panels 15. Referring to FIG. 4, bright lines or dark lines are disposed on areas 60 of a display screen corresponding to the boundaries. That is, as the distances d1 and d2 of the adjacent light guide panels 15 are decreased, the amount of light emitted to the front side through the boundaries is increased. Thus, the brightness of light emitted from the areas 60 corresponding to the boundaries is increased to cause bright lines on the display screen.

Also, as the distances d1 and d2 of the adjacent light guide panels 15 are increased, the amount of light emitted to the front side through the boundaries is decreased. Thus, the brightness of light emitted from the areas 60 corresponding to the boundaries is decreased to cause dark lines on the display screen.

Thus, according to the embodiment, the distances d1 and d2 between the adjacent light guide panels 15 are adjusted within a range for preventing bright or dark lines at the boundaries therebetween, so as to improve the quality of a display image.

Table 1 below shows occurrence of a bright or dark line according to the distance d1 between the adjacent light guide panels 15. The distance d1 denotes a distance between the light guide panels 15 adjacent in the lateral direction (x-axis direction), that is, in the direction perpendicular to the direction of light emitted from the light source 13

The following test results show whether a plurality of testers visually perceive a bright or dark line when the distances d1 and d2 between the adjacent light guide panels 15 are varied. When 90% or more of the testers perceived a bright or dark line, it was assumed that a bright or dark line occurred.

TABLE 1

| | | OCCURRENCE OF | OCCURRENCE OF |
|---|---|---|---|
| DISTANCE (d1) | | BRIGHT LINE | DARK LINE |
| 0.05 | mm | ◯ | X |
| 0.06 | mm | ◯ | X |
| 0.07 | mm | ◯ | X |
| 0.08 | mm | ◯ | X |
| 0.09 | mm | ◯ | X |
| 0.1 | mm | X | X |
| 0.2 | mm | X | X |
| 0.3 | mm | X | X |
| 0.8 | mm | X | X |
| 1.3 | mm | X | X |
| 1.8 | mm | X | X |
| 2.3 | mm | X | X |
| 2.8 | mm | X | X |
| 3.3 | mm | X | X |
| 3.8 | mm | X | X |
| 4.3 | mm | X | X |
| 4.8 | mm | X | X |
| 5.3 | mm | X | X |
| 5.8 | mm | X | X |
| 6.3 | mm | X | X |
| 6.8 | mm | X | X |
| 6.9 | mm | X | X |
| 7.0 | mm | X | X |
| 7.1 | mm | X | ◯ |
| 7.2 | mm | X | ◯ |
| 7.3 | mm | X | ◯ |
| 7.4 | mm | X | ◯ |

Referring to Table 1, when the distance d1, between the light guide panels 15 adjacent in the direction perpendicular to the direction of light emitted from the light source 13, that is, in the lateral direction (x-axis direction), is less than 0.1 mm, the brightness of light emitted from the boundary is increased, so that a bright line may occurs on the display screen. When the distance d1 is greater than 7.0 mm, the brightness of light emitted from the boundary is decreased, so that a dark line may occurs on the display screen.

Thus, to prevent a bright or dark line degrading quality of the display screen, the distance d1, between the light guide panels 15 adjacent in the direction perpendicular to the direction of light emitted from the light source 13, that is, in the lateral direction (x-axis direction), may range from 0.1 mm to 7.0 mm.

However, when the distance d1 is decreased, the adjacent light guide panels 15 may be collided and damaged by external shock. Thus, the distance d1 between the light guide panels 15 adjacent in the perpendicular direction to the direction in which light is emitted from the light source 13, that is, in the lateral direction (x-axis direction) is about 0.3 mm or greater, so as to protect the light guide panels 15 from external shock.

As the distance d1 is increased, the ratio of the area of the light guide panels 15 to the entire area of the backlight unit 100 may be reduced, which may reduce the brightness of light emitted from the backlight unit 100 to the display module 200. Thus, to prevent the brightness decrease of light provided to the display module 200, the distance d1 between the light guide panels 15 may be about 2.5 mm or less.

Referring again to FIG. 3, when light emitted from the light source 13 is incident to a lower end 120 of the light guide panel 15, and then travels to an upper end 130 of the light guide panel 15, the amount of light emitted from the lower end 120 adjacent to the light source 13 to the front side of the backlight unit 100 may be greater than the amount of light emitted from the upper end 130 distant from the light source 13 to the front side of the backlight unit 100. Accordingly, a portion of the display screen corresponding to the lower end 120 of the light guide panel 15 may be brighter than a portion of the display screen corresponding to the upper end 130 of the light guide panel 15.

Thus, the distance d2, between the light guide panels 15 adjacent in the direction parallel to the direction of light emitted from the light source 13, that is, in the longitudinal direction (y-axis direction), is decreased such that a high brightness value of the lower end 120 compensates for a low brightness value of the upper end 130, and the uniformity of the entire brightness of the display screen is maintained.

For example, the distance d2, between the light guide panels 15 adjacent in the direction parallel to the direction of light emitted from the light source 13, that is, in the longitudinal direction (y-axis direction), may be less than the distance d1 disposed in the lateral direction (x-axis direction).

However, when the distance d2, between the light guide panels 15 adjacent in the direction parallel to the direction of light emitted from the light source 13, that is, in the longitudinal direction (y-axis direction), is excessively decreased, a bright line may occur in the lateral direction (x-axis direction). Thus, the distance d1, between the light guide panels 15 adjacent in the direction perpendicular to the direction of light emitted from the light source 13, that is, in the lateral direction (x-axis direction), may range from one to two times the distance d2, between the light guide panels 15 adjacent in the direction parallel to the direction of light emitted from the light source 13, that is, in the longitudinal direction (y-axis direction).

Table 2 below shows occurrence of a bright or dark line according to the distance d2 between the adjacent light guide panels 15. The distance d2 denotes the distance between the light guide panels 15 adjacent in the longitudinal direction (y-axis direction), that is, in the direction parallel to the direction of light emitted from the light source 13.

TABLE 2

| | | OCCURRENCE OF | OCCURRENCE OF |
|---|---|---|---|
| DISTANCE (d2) | | BRIGHT LINE | DARK LINE |
| 0.05 | mm | ◯ | X |
| 0.06 | mm | ◯ | X |
| 0.07 | mm | ◯ | X |
| 0.08 | mm | ◯ | X |
| 0.09 | mm | ◯ | X |
| 0.1 | mm | X | X |
| 0.2 | mm | X | X |
| 0.7 | mm | X | X |
| 1.2 | mm | X | X |
| 1.7 | mm | X | X |
| 2.2 | mm | X | X |
| 2.7 | mm | X | X |
| 3.2 | mm | X | X |
| 3.7 | mm | X | X |
| 4.2 | mm | X | X |
| 4.7 | mm | X | X |
| 4.8 | mm | X | X |
| 4.9 | mm | X | X |
| 5.0 | mm | X | X |
| 5.1 | mm | X | ◯ |
| 5.2 | mm | X | ◯ |
| 5.3 | mm | X | ◯ |
| 5.4 | mm | X | ◯ |

Referring to Table 2, when the distance d2, between the light guide panels 15 adjacent in the direction parallel to the direction of light emitted from the light source 13, that is, in the longitudinal direction (y-axis direction), is less than 0.1 mm, the brightness of light emitted from the boundary is increased, so that a bright line may occurs on the display screen. When the distance d2 is greater than 5.0 mm, the brightness of light emitted from the boundary is decreased, so that a dark line may occurs on the display screen.

Since upper end 130 of the lower one of light guide panels 15 adjacent in the longitudinal direction (y-axis direction) has a low brightness value, a dark line occurs when distance d2, disposed in the longitudinal direction (y-axis direction), is greater than 5.0 mm. Thus, the range of distance d2 in which a dark line occurs is less than that of distance d1.

Thus, to secure the brightness uniformity of the display screen by preventing a bright or dark line degrading quality of the display screen, the distance d2, between the light guide panels 15 adjacent in the direction parallel to the direction of light emitted from the light source 13, that is, in the longitudinal direction (y-axis direction), may range from 0.1 mm to 5.0 mm.

However, when the distance d2 is decreased, the adjacent light guide panels 15 may be collided and damaged by external shock. Thus, the distance d2 between the light guide panels 15 adjacent in the direction in which light is emitted from the light source 13, that is, in the longitudinal direction (y-axis direction) is about 0.3 mm or greater, so as to protect the light guide panels 15 from external shock.

As the distance d2 is increased, the ratio of the area of the light guide panels 15 to the entire area of the backlight unit 100 may be reduced, which may reduce the brightness of light emitted from the backlight unit 100 to the display module 200. Thus, to prevent the brightness decrease of light provided to the display module 200, the distance d2 between the light guide panels 15 may be about 2.5 mm or less.

Although the light source 13 is disposed on the lower side of the light guide panel 15 on the basis of the front side as illustrated in FIGS. 3 and 4, the present disclosure is not limited thereto. That is, the light source 13 may be disposed on the upper, left or right side of the light guide panel 15.

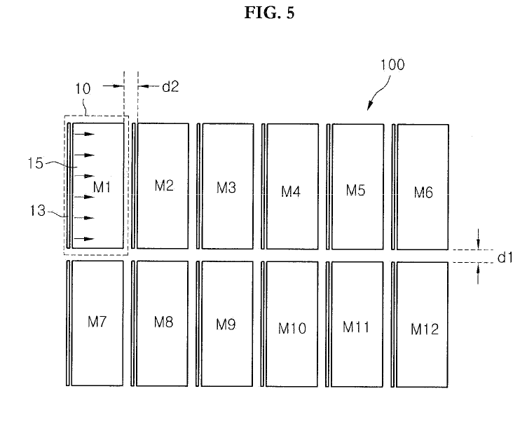

FIG. 5 is a plan view illustrating the backlight unit 100 according to an embodiment. (A description of the same part as those described with reference to FIGS. 1 to 4 will be omitted). Referring to FIG. 5, the light source 13 may be disposed at the left side of the light guide panel 15 on the basis of FIG. 5. Thus, light emitted from the light source 13 may be laterally incident to the left end of the light guide panel 15, and then travel to the right end of the light guide panel 15, that is, to the lateral direction (x-axis direction).

In this case, to prevent a bright or dark line degrading quality of a display screen as described with reference to FIGS. 3 and 4, the distance d1, between the light guide panels 15 adjacent in the direction perpendicular to the direction of light emitted from the light source 13, that is, in the longitudinal direction (y-axis direction), may range from 0.1 mm to 7.0 mm.

To secure the brightness uniformity of the display screen by preventing a bright or dark line from occurring on the display screen, the distance d2, between light guide panels 15 adjacent in the direction parallel to the direction of light emitted from light source 13, that is, in the lateral direction (x-axis direction), may range from 0.1 mm to 5.0 mm.

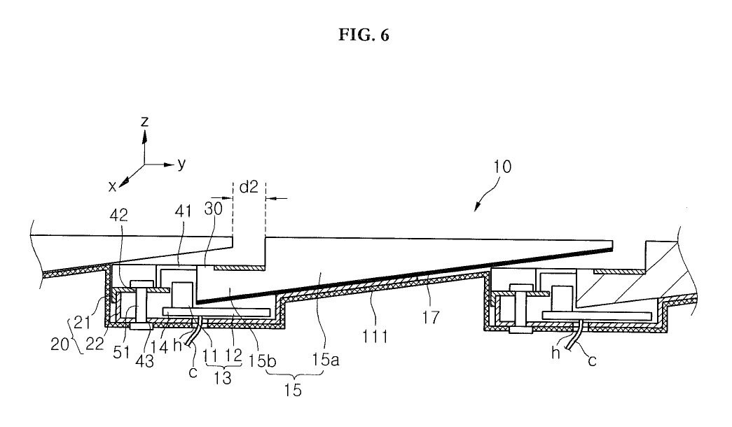

FIG. 6 is a cross-sectional view illustrating a backlight unit according to an embodiment. Referring to FIG. 6, the optical assembly 10 may include the light source 13, the light guide panel 15, a reflecting member 17, and a side cover 20 for fixing the light source 13 and the light guide panel 15. The side cover 20 provides a fixing position with respect to the bottom cover 110 and may include a first side cover 21 and a second side cover 22.

The light guide panel 15 may include a first part 15b and a second part 15b. The second part 15a may include an upper surface generating a surface light source, a lower surface facing the upper surface, and four side surfaces.

The first part 15b may horizontally protrude from one of the side surfaces of the second part 15a along the lower portion of the side surface. The first part 15b may be a light incident part having a light incident surface to which light is incident from the light source 13, and the second part 15a may be a light emitting part that emits light, laterally incident through the light incident part, to the upper side, thus substantially providing the light to the display panel 210.

According to the embodiment, adjacent optical assemblies 10, and particularly, two adjacent light guide panels 15, may overlap each other in a predetermined area. For example, the light source 13, the first part 15b, i.e., the light incident part, and the side cover 20 are disposed on one side of the optical assembly 10, and the light source 13, the first part 15b, and the side cover 20 may be disposed under the adjacent optical assembly 10, and particularly, under the second part 15a of the adjacent optical assembly 10, that is, under the light emitting part.

That is, as described above, when the number of rows of the light guide panels 15 arrayed along the first direction in which light is emitted from the light source 13 is N, the light emitting part of the light guide panel 15 in a K^{th} row (K is one of 1 to N−1) of the N rows may be disposed above and overlap the light incident part of the light guide panel 15 in a K+1^{th} row.

The optical assemblies 10 partially overlap each other to hide the light source 13, the first part 15b, and the side cover 20 from the front side. As described above, the adjacent optical assemblies 10 of the backlight unit 100 overlap each other to prevent a bright line or a dark line at the boundary of the optical assemblies 10 and improve the uniformity of light.

As illustrated in FIG. 6, when the adjacent light guide panels 15 overlap each other in a predetermined area, the distance d2 between the adjacent light guide panels 15 may be defined as a distance between portions of the light guide panels 15 emitting light upward. That is, distance d2 may be the distance between second parts 15a, i.e., between the light emitting parts of the adjacent light guide panels 15.

More particularly, when the number of rows of light guide panels 15 arrayed along the first direction in which light is emitted from light source 13 is N, the light emitting part of light guide panel 15 in the K^{th} row (K is one of 1 to N−1) of the N rows may be spaced distance d2 from the light emitting part of light guide panel 15 in the K+1^{th} row.

In accordance with one embodiment, the distance d2 may correspond to a gap and substantially no discontinuity of light on the display device may be visible, at least at a viewing distance from the display device. The gap may also produce a substantially uniform display brightness including at boundaries between adjacent ones of the light guide panels.

According to one embodiment, distance d2 may be considered to be the distance between light guide panels that are adjacent in a direction parallel to the direction of light emitted from the light source 13. Distance d2 may, for example, range from 0.1 mm to 5.0 mm as described above.

As shown in FIG. 6, light guide panels 15 adjacent in the direction perpendicular to the direction of light emitted from light source 13, that is, in the x-axis direction do not overlap each other. Accordingly, the distance of light guide panels adjacent in the x-axis direction may be equal to distance d1 as described with reference to FIGS. 3 to 5.

The upper or lower surface of the light guide panel 15 may be provided with a diffusion pattern (not shown) that has a predetermined pattern to diffuse and reflect incident light, thus improving the uniformity of light at the front surface of the light guide panel 15.

The lower surface of the second part 15a of the light guide panel 15 may be inclined at a predetermined angle, so as to gradually decrease in thickness from an adjacent portion to the first part 15b to a distant portion from the first part 15b. That is, the light emitting part of the light guide panel 15 may decrease in thickness from a first side adjacent to the light incident part to a second side distant from the light incident part.

The lower surface of the light guide panel 15 may be provided with the reflecting member 17 that reflects light, laterally incident through the first part 15b and guided in the light guide panel 15, to the upper side. In addition, the reflecting member 17 may prevent interference of light generated between the overlapped optical assemblies 10.

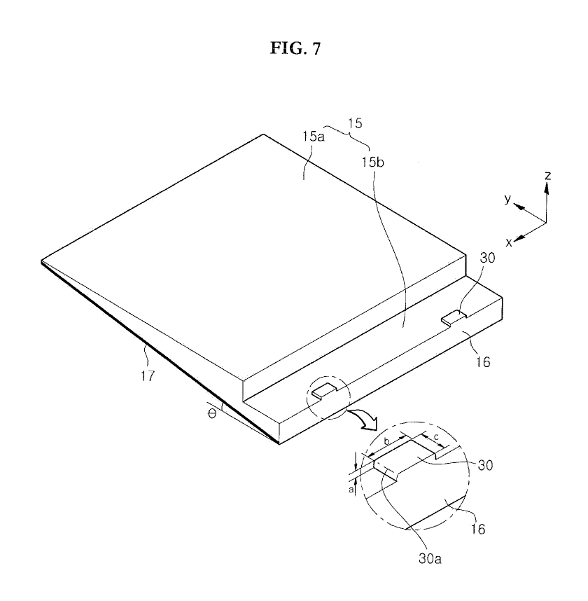

FIG. 7 is a perspective view illustrating the light guide panel 15 of the backlight unit 100. Referring to FIGS. 6 and 7, light guide panel 15, and particularly, first part 15b of light guide panel 15 may include a protrusion 30 protruding with a predetermined height ‘a’. The protrusion 30 may be provided to at least two points in the x-axis direction on the upper surface of the first part 15b of the light guide panel 15.

The shape of the protrusion 30 may be varied. For example, the protrusion may have a rectangular parallelepiped shape. The protrusion(s) 30 is/are caught by first side cover 21 to prevent the shaking of light guide panel 15 along the x-axis and the y-axis. An edge 30a of the protrusion 30 may be rounded to prevent a case that a crack is formed at the protrusion 30 by shock due to the movement of light guide panel 15.

The height ‘a’ of protrusion 30 may range from about 0.1 to 0.6 mm from the upper surface of first part 15b, and a width ‘b’ ranging from about 2 to 5 mm along the x-axis. The protrusion may have a width ‘c’ ranging from about 1 to 3 mm along the y-axis.

The protrusion 30 may be disposed between neighboring LEDs 11 and adjacent to a light incident surface 16 on the upper surface of the first part 15b, so as to prevent optical interference of light emitted from the LEDs 11 due to the protrusion 30 integrally formed with the light guide panel 15.

The light source 13 may include at least one of the LEDs 11, and module substrate 12 to which LEDs 11 are mounted. The LEDs 11 may be arrayed along the x-axis on the module substrate 12 and adjacent to the light incident surface 16 of the first part 15b.

The module substrate 12 may include one of a flexible substrate and a printed circuit board (PCB) such as a metal core PCB and a FR-4 PCB, but is not limited thereto. A thermal pad may be disposed under the module substrate 12 between the module substrate 12 and the second side cover 22.

Light emitted from the LED 11 is laterally incident to the first part 15b. Colors of light incident from the LEDs 11 may be mixed in the light guide panel 15 including the first part 15b.

Light emitted from the LEDs 11 is guided in the first part 15b and incident to the second part 15a. The light incident to the second part 15a is reflected upward from the reflecting member 17 disposed on the lower surface of the second part 15a. At this point, the diffusion pattern disposed on the lower surface of the light guide panel 15 diffuses and spreads the light to improve the uniformity of the light.

The LEDs 11 may be spaced a predetermined distance from each other on the module substrate 12. The LEDs 11 may be disposed in an oblique direction with respect to the protrusion 30 to minimize optical effect due to the protrusion 30 of the light guide panel 15. Accordingly, the distance between the LEDs 11 around the protrusion 30 may be greater than the distance between the other LEDs 11.

The distance between a portion of the LEDs 11 may be greater than the distance between the other LEDs 11 to secure a coupling space of the first side cover 21 and the second side cover 22 and minimize optical effect due to coupling force for pressing the light guide panel 15. For example, when a first distance ‘d’ between the adjacent LEDs 11 is about 10 mm, a second distance ‘e’ of LEDs 11 around the coupling space may be about 13 mm. The colors of light emitted from the LEDs 11 are mixed in the light guide panel 15 including the first part 15b to uniformly provide the light to the second part 15a.

The side cover 20, surrounding the light source 13 and a portion of the light guide panel 15, may include the first side cover 21 disposed on the light source 13 and the first part 15b of the light guide panel 15, and the second side cover 22 disposed under the first part 15b. The side cover 20 may be formed of plastic or metal.

The second side cover 22, facing the lower surface of the first part 15b, may be bent upward (along a z-axis) at the lower surface of the first part 15b to face the light incident surface 16. A portion 22a of the second side cover 22 may be inclined along the lower surface of the light guide panel 15, that is, along an inclined surface of the light guide panel 15. The second side cover 22 may accommodate the light source 13.

The first side cover 21 is coupled to the second side cover 22 through a first fixing member 51 to prevent the shaking of the light source 13 and the light guide panel 15 due to external shock, and particularly, prevent the shaking along the z-axis.

The second side cover 22 supports the inclined surface of the light guide panel 15 to firmly maintain alignment of the light guide panel 15 with the light source 13 and protect the light guide panel 15 and the light source 13 from external shock. The first side cover 21 may have first holes 41 at positions corresponding to the protrusions 30 of the first part 15b.

The first holes 41 may be larger than the protrusions 30 such that the protrusions 30 are fitted and caught to the first holes 41. The protrusion 30 disposed in the first hole 41 partially has a predetermined gap that may be a margin for preventing the torsion of the light guide panel 15 when the light guide panel 15 is expanded by environmental change such as sharp temperature increase. In this case, the rest of the protrusion 30 without the predetermined gap may be in contact with the first side cover 21 to increase fixing force thereof. At least one second hole 42 may be further disposed in the first side cover 21. The second side cover 22 may have at least one third hole 43 at a position corresponding to the second hole 42.

The backlight unit 100 configured as described above may be disposed in the bottom cover 110 having a box shape with an open top. The bottom cover 110 includes a recess part 111 to which the optical assembly 10 is fixed, and a projection part 112 disposed under the inclined portion of the light guide panel 15 of the optical assembly 10 and protruding from the recess part 111 in the second direction (z-axis direction).

A hole h passes through both the bottom cover 110 and the side cover 20. A cable c extending from a substrate 14 may be connected through the hole h to a driving substrate 250 that is provided to the rear surface of the bottom cover 110.

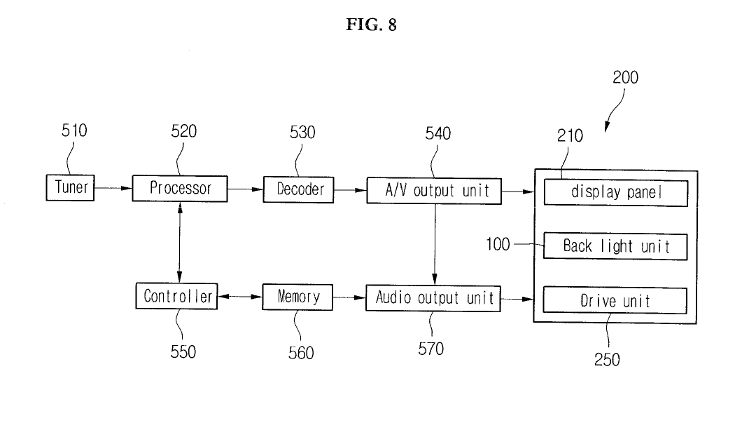

FIG. 8 shows operating elements for a display apparatus according to an embodiment. Referring to FIG. 8, the display apparatus 1 includes the display module 200, a tuner 510, a processor 520, a decoder 530, an A/V output unit 540, a controller 550, a memory 560, and an audio output unit 570.

A broadcast data stream is transmitted from the tuner 510 through the processor 520, the decoder 530, and the A/V output unit 540 to the display module 200, and is displayed. An operation of the tuner 510 or the processor 520 may be controlled by the controller 550 that may include the memory 560.

When the display apparatus 1 configured as described above is operated to select an arbitrary channel, the controller 550 controls the tuner 510 and the processor 520 to select the channel, and the processor 520 divides a data stream of a broadcast program, provided through the channel, into an audio data and a video data, and outputs them.

Then, the decoder 530 decodes the audio data and the video data output from the processor 520 into an audio signal and a video signal, so that the audio signal and the video signal can be output through the A/V output unit 540 to the display module 200 or the audio output unit 570 such as a speaker unit. A driving unit 250 drives the backlight unit 100 to display the output video signal on the display panel 210. A broadcast data stream transmitted to the processor 520 may be provided through the Internet.

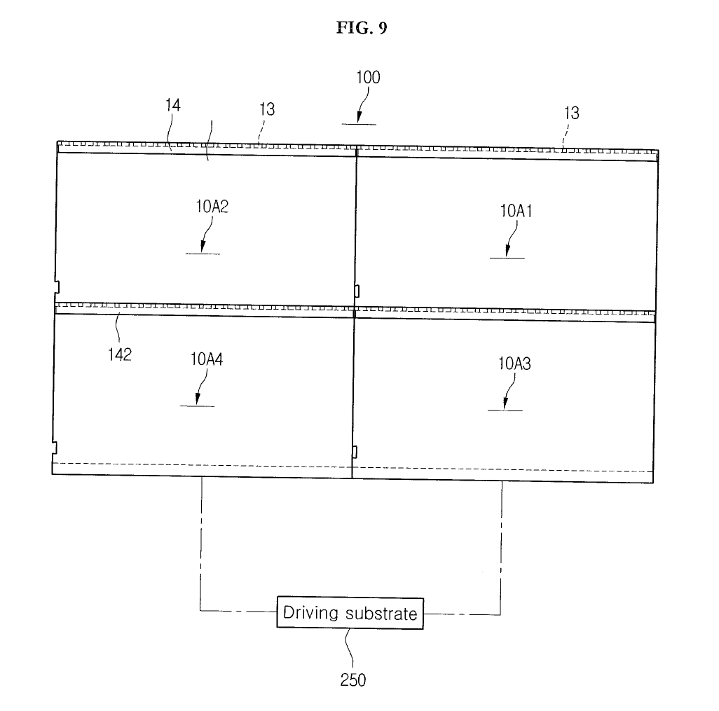

FIG. 9 shows operating elements for a back light unit according to an embodiment. Referring to FIG. 9, a plurality of optical assemblies 10A1, 10A2, 10A3, 10A4, each of which includes the light guide panel 15 and the reflecting member 17, are arrayed to form the backlight unit 100.

That is, the circuit substrates 14 and the light sources 13 are disposed on one side or two sides of the light guide panel, and the optical assemblies 10A1, 10A2, 10A3, 10A4 including the light guide panels 15 and the reflecting members 17 are arrayed on the light guide parts 110, so as to constitute the backlight unit 100.

The backlight unit 100 fabricated by coupling the optical assemblies 10A1, 10A2, 10A3, 10A4 as described above, or the light sources 13 connected to the backlight unit 100 may be independently or divisionally driven in group units by the driving substrate 250, thus significantly reducing power consumption of the backlight unit 100. In this case, the division driving may be set and performed in module units, in light source units of the light sources 13, or in light source set units that are logically grouped.

That is, the light sources 13 may be grouped into primary light source groups that constitute sides respectively of modules, so that the light sources 13 can be driven in primary group units. Alternatively, the light sources 13 may be grouped into sub groups of the light sources 13 that constitute sides respectively of modules, so that the light sources 13 can be driven in sub group units.

As described above, according to the current embodiment, the light guide panels 15 are minimized, and the light sources 13 are continuously attached to the side surfaces of the light guide panels 15, thus securing a predetermined amount of light and dissipating heat. Specifically, the light sources 13 attached to the side surfaces of the light guide panels 15 are optically hidden.

According to the embodiment of FIG. 1, the small light guide panels are continuously attached to each other in light guide module manner to constitute the entire area of the display. Thus, the light sources can be disposed between the light guide panels, and the identical light guide panels can be used regardless of the size of the display.

The light guide panels are provided in module form, and continuously attached in tile manner, so as to form a large screen. Thus, identical parts can be applied to various sizes of televisions by varying the number thereof, so that the parts can be standardized.

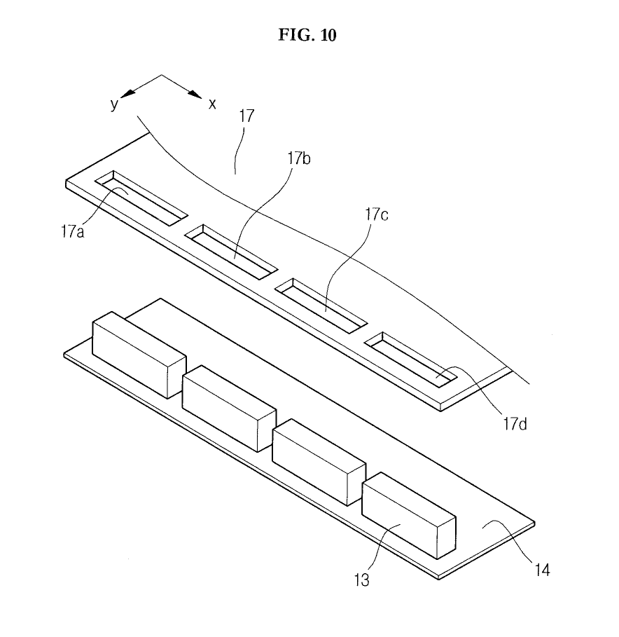

FIG. 10 is a perspective view illustrating a reflecting element and a substrate according to an embodiment. Referring to FIG. 10, at least one portion of the reflecting member 17 of the optical assembly 10 is placed on the substrate 14. The portion of the reflecting member 17 placed on the substrate 14 is provided with holes 17a, 17b, 17c, and 17d through which the light sources 13 arrayed on the substrate 14 pass.

In more detail, the holes 17a, 17b, 17c, and 17d have shapes and sizes corresponding to the light sources 13, and disposed at positions corresponding to the light sources 13. Thus, when assembling the optical assembly 10, the light sources 13 are inserted into the holes 17a, 17b, 17c, and 17d of the reflecting member 17, so that the position of the reflecting member 17 relative to the substrate 14 can be fixed.

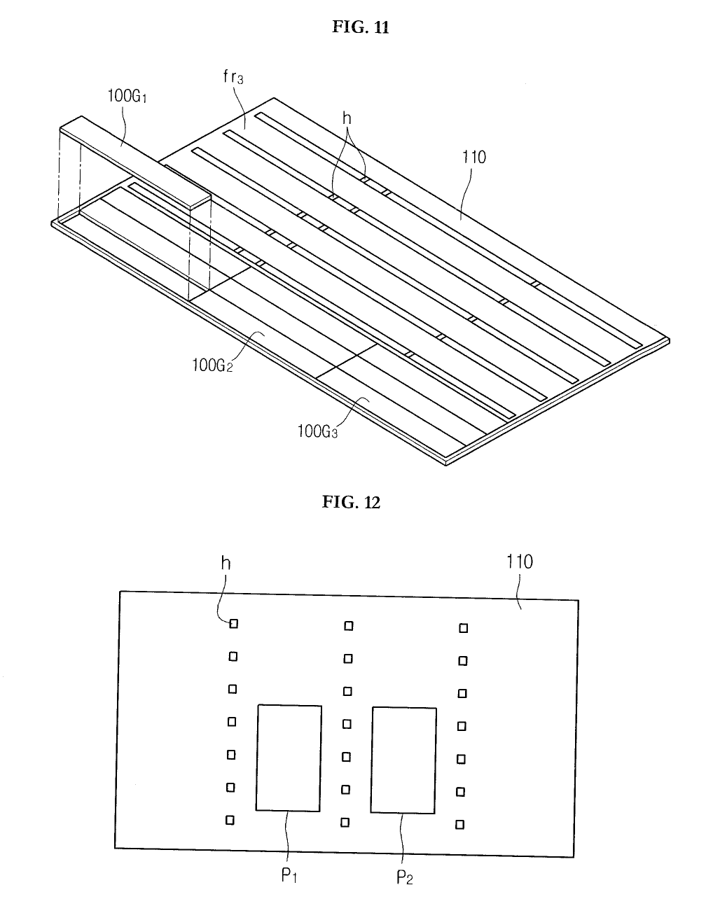

FIG. 11 is a perspective view illustrating a backlight unit according to an embodiment, and FIG. 12 is a plan view of a rear surface of a bottom cover of FIG. 11. The current embodiment is the same as the embodiment of FIG. 1 except for a bottom cover and an optical assembly, which will be described in detail.

Referring to FIGS. 11 and 12, a plurality of optical assemblies 100G1, 100G2, and 100G3 are arrayed in three lines on the bottom cover 110 of the backlight unit 100. A plurality of holes h are disposed in the bottom cover 110 to connect connection parts 148 provided to the rear surfaces of the substrates 14 respectively of the optical assemblies 100G1, 100G2, and 100G3 to driving substrates P1 and P2 provided to the rear surface of the bottom cover 110.

In more detail, the optical assemblies 100G1, 100G2, and 100G3 are arrayed in one to three lines on the bottom cover 110. The connection parts 148 of the substrates 14 may be directly disposed on the bottom cover 110 in correspondence with the line or the lines, or the holes h for connecting the connection parts 148 to the driving substrates P1 and P2 may be disposed in the bottom cover 110 in correspondence with the line or the lines.

The driving substrates P1 and P2 are provided to the rear surface of the bottom cover 110, and may be referred to as a first driving substrate and a second substrate, respectively. The first driving substrate P1 is disposed between neighboring first and second lines of the three lines, and the second driving substrate P2 is disposed between neighboring second and third lines of the three lines. Hereinafter, a configuration of the substrate 14 of the optical assembly 10 will now be described in detail.

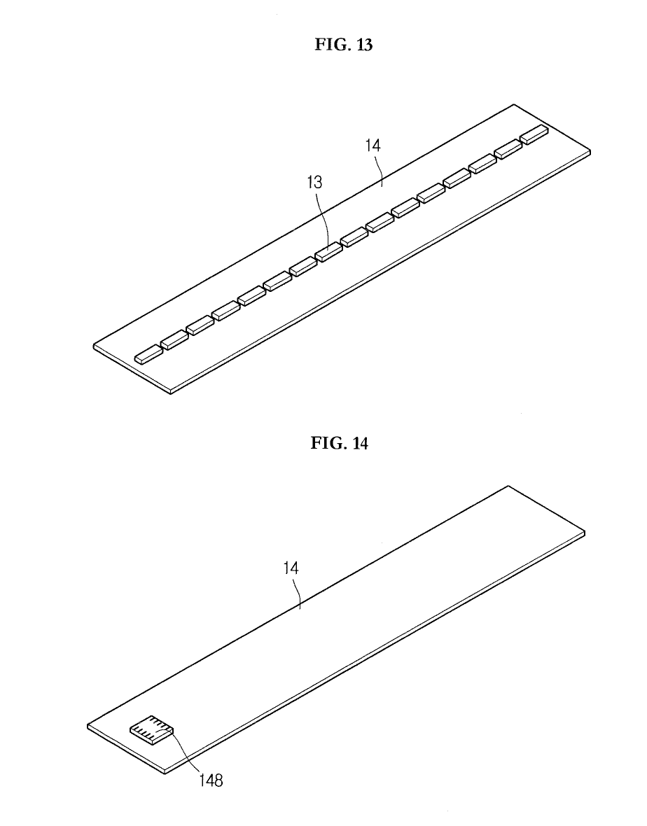

FIG. 13 is a perspective view of a substrate of an optical unit of FIG. 11, and FIG. 14 is a perspective view of a rear surface of the substrate of FIG. 13.

Referring to FIGS. 13 and 14, the light sources 13 are disposed on a surface of the substrate 14, and the connection part 148 is disposed on an inner surface of the substrate 14 facing the bottom cover 110.

The connection part 148 is connected with a cable member (not shown) for transmitting a control signal from the driving substrates P1 and P2, and protrudes from the inner surface of the substrate 14 to the bottom cover 110. The connection part 148 may directly pass through the hole h provided to the bottom cover 110.

The cable member has a side connected to the connection part 148, and another side connected to the driving substrates P1 and P2, to transmit the control signal of the driving substrates P1 and P2 through the connection part 148 to the substrate 14 and the light sources 13.

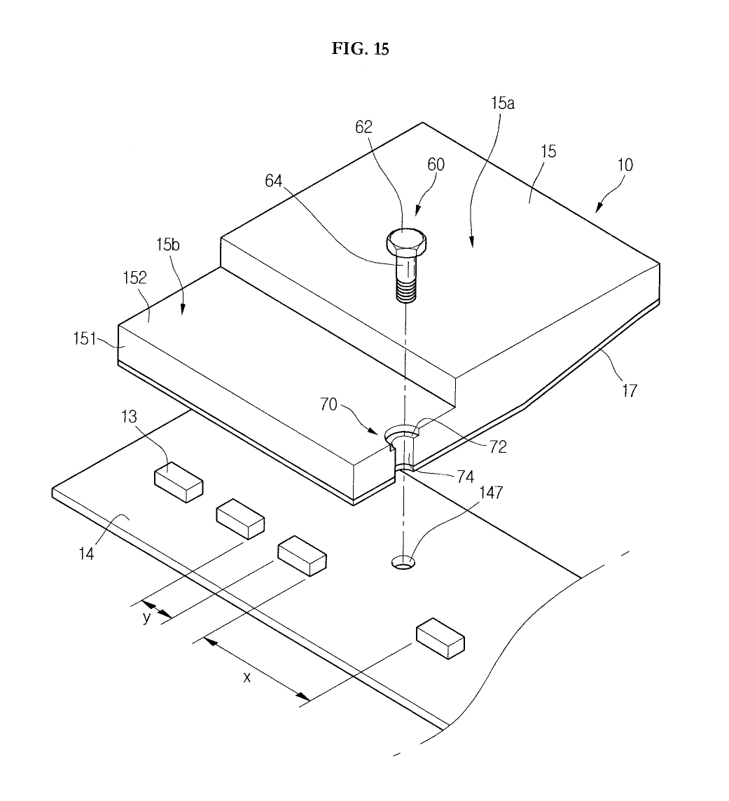

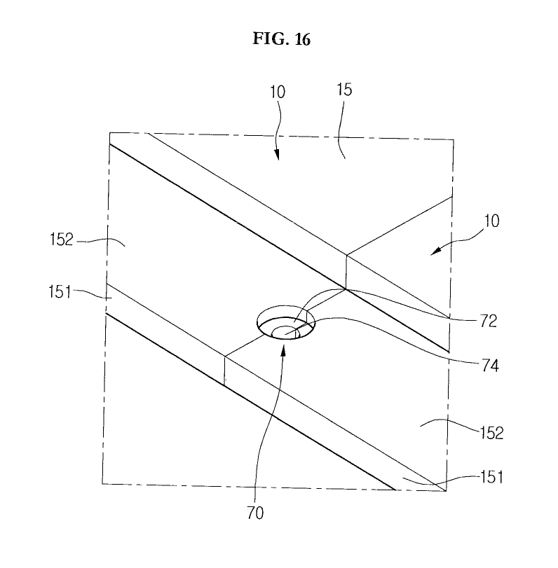

FIG. 15 is an exploded perspective view of an optical assembly according to an embodiment, and FIG. 16 is a perspective view of two light guide panels that are aligned of FIG. 16.

The current embodiment is the same as the embodiment of FIG. 1 except for a fixing structure of a light guide panel, which will now be described in detail.

Referring to FIGS. 15 and 16, the light incident part 15b of the light guide panel 15 of the optical assembly 10 is provided with a fixing part 70 where a fixing member 60, for fixing the light guide panel 15 to the substrate 14 or the bottom cover 110, is disposed.

The fixing part 70 of one of the adjacent light guide panels 15 is in contact with the fixing part 70 of the other to have a shape corresponding to the entire shape of the fixing member 60.

The fixing part 70 includes a recess part 72 that is disposed in the upper surface 152 of the light incident part 15b, and a through part 74 that passes through the lower side of the recess part 72. The recess part 72 is recessed with a diameter and a thickness corresponding to a head part 62 of the fixing member 60. A fixing member body 64 of the fixing member 60 having a spiral is inserted and fixed to the through part 74.

The substrate 14 is provided with a fixing hole 147 that is disposed at a position corresponding to the through part 74 to fix at least one portion of the fixing member body 64 passing through the through part 74. A distance x between the light sources 13 at a portion where the fixing hole 147 is disposed is greater than a distance y between the light sources 13 at a portion without the fixing hole 147 to prevent optical interference due to the fixing member 60.

Thus, when the light guide panels 15 of the backlight unit 100 are adjacent to each other, the fixing member body 64 passes through the through part 74 and is fixed to the substrate 14 or the bottom cover 110, and the head part 62 provided to the side of the fixing member body 64 compresses the recess part 72 to the substrate 14 or the bottom cover 110, thus fixing the light guide panels 15 to the substrate 14 or the bottom cover 110.

Although the configurations according to the aforementioned embodiments are provided independently, they may be combined to each other.

According to the embodiments, the module-type backlight unit including the light guide panels provides light to the display panel. Thus, the thickness of the display apparatus can be decreased and contrast of a display image can be improved using the entire driving method or a local driving method such as the local dimming method and the impulsive method. In addition, the distances between the light guide panels are adjusted to prevent bright lines or dark lines from occurring at the boundaries between the light guide panels, thus improving the quality of a display image.

The embodiments described herein provide a backlight unit and a display apparatus including the backlight unit, which improve the quality of a display image.

In one embodiment, a backlight unit includes a substrate; a light source on the substrate, the light source emitting light with a predetermined orientation angle with respect to a first direction; and N (N is 2 or greater) light guide panels each including: a light incident part having a light incident surface to light from the light source is laterally incident; and a light emitting part emitting the incident light upward, wherein at least one portion of the light emitting part of a Kth (K is one of 1 to N−1) light guide panel of the N light guide panels is disposed on an upper side of the light incident part of a K+1th light guide panel, and the light emitting part of the Kth light guide panel is spaced a first distance from the light emitting part of the K+1th light guide panel.

In another embodiment, a backlight unit includes a substrate; a light source on the substrate, the light source emitting light with a predetermined orientation angle with respect to a first direction; and a plurality of light guide panels each including: a light incident part having a light incident surface to light from the light source is laterally incident; and a light emitting part emitting the incident light upward, wherein the light emitting part of the light guide panel includes a portion that decreases in thickness from a side adjacent to the light incident part to a side distant from the light incident part, the light guide panels includes N (N is 2 or greater) light guide panels arrayed in the first direction, and M (M is 2 or greater) light guide panels arrayed in a perpendicular direction to the first direction, the light emitting part of a Kth (K is one of 1 to N−1) light guide panel of the N light guide panels is spaced a first distance from the light emitting part of a K+1th light guide panel, and the light emitting part of an Lth (L is one of 1 to M−1) light guide panel of the M light guide panels is spaced a second distance from the light emitting part of an L+1th light guide panel.

In further another embodiment, a display apparatus includes: a backlight unit divided into a plurality of blocks and dividedly drivable in a block unit; and a display panel on an upper side of the backlight unit, wherein the backlight unit includes: a substrate; a light source on the substrate, the light source emitting light with a predetermined orientation angle with respect to a first direction; and N (N is 2 or greater) light guide panels each including: a light incident part having a light incident surface to light from the light source is laterally incident; and a light emitting part emitting the incident light upward, wherein at least one portion of the light emitting part of a Kth (K is one of 1 to N−1) light guide panel of the N light guide panels is disposed on an upper side of the light incident part of a K+1th light guide panel, and the light emitting part of the Kth light guide panel is spaced a first distance from the light emitting part of the K+1th light guide panel.

A backlight unit includes: N light guide panels arranged in a first direction, N being at least 2, a light guide panel having a light incident section to receive light from the first direction and a light emitting section adjacent to the light incident section to emit light received from the light incident section in a second direction, the first and second directions being different directions; and a plurality of light sources, the incident section of the light guide panel being adjacent to at least one light source, wherein a portion of the light emitting section of a Kth (K is one of 1 to N−1) light guide panel overlaps a portion of the light incident section of a K+1th light guide panel, and the light emitting section of the Kth light guide panel is spaced a first distance from the light emitting section of the K+1th light guide panel.

A backlight unit comprises: M light guide panels, M being at least 2, a light guide panel having a light incident section to receive light from the first direction and a light emitting section adjacent to the light incident section to emit light received from the light incident section in a second direction, the first and second directions being different directions and the M light guide panels being arranged in the second direction; and a plurality of light sources, the incident section of the light guide panel being adjacent to at least one light source, wherein the light emitting section of an Lth light guide panel (L is one of 1 to M−1) of the M light guide panels is spaced a first distance from the light emitting section of an L+1th light guide panel.

A display apparatus includes the back light unit of above, wherein the display apparatus further comprises: a display panel provided over the back light unit; and a drive unit for supplying drive power to at least one of the display panel or the light sources, wherein the N×M light guide panels are divided into a plurality of division driving areas, wherein the light guide panels in at least one division driving area emit light independently from the light guide panels in at least one other division driving areas such that a brightness of the at least one division driving area is different from brightness of the at least one other division driving areas.

The present disclosure also provides a “green” technology for display devices. Presently, the backlight is generally turned on continuously, even when the display of the entire screen is not desirable. For example, the prior art display allows control of the resolution of the entire display screen but not the size of the display screen. However, in certain instances, a smaller screen area may be desirable for lower resolution images. The size of the display area can be controlled based on the present disclosure. For example, instead of viewing images and programs in 42 inch display, the display screen size can be reduce to 32 inches by turning off the light sources for appropriate number of light guide plates located at the periphery of the display device. As can be appreciated, the location and size of the display area can be controlled based on program or user needs. As can be appreciated, multiple configuration may be possible based on turning on or off the light sources for appropriate number of light guide plates (light guide panels or light guide modules or assemblies) based on application and user configuration.

This application is related to Korean Applications Nos. 10-2008-0049146 filed on May 27, 2008, 10-2008-0061487 filed on Jun. 27, 2008, 10-2008-0099569 filed on Oct. 10, 2008, 10-2009-0035029 filed on Apr. 22, 2009, 10-2009-0036472 filed Apr. 27, 2009, 10-2009-0052805 filed on Jun. 15, 2009, 10-2009-0061219 filed Jul. 6, 2009, 10-2009-0071111 filed Aug. 2, 2009, 10-2009-0075120 filed on Aug. 14, 2009, 10-2009-0080654 filed Aug. 28, 2009, 10-2009-0098844 filed on Oct. 16, 2009, and 10-2009-0098901 filed on Oct. 16, 2009, whose entire disclosures are incorporated herein by reference. Further, this application is related to U.S. Provisional Patent Application No. 61/219,480 filed on Jun. 23, 2009; 61/230,844 filed on Aug. 3, 2009; 61/233,890 filed on Aug. 14, 2009; and 61/237,841 filed on Aug. 28, 2009 and U.S. application Ser. No. 12/453,885 filed on May 22, 2009, Ser. No. 12/618,603 filed on Nov. 13, 2009, Ser. No. 12/632,694 filed on Dec. 7, 2009, and LGE-162, LGE-163, HI-0400, HI-0412, HI-0413, HI416 and HI-0420 all filed on Mar. 19, 2010, whose entire disclosures are incorporated herein by reference.

It will be apparent to those skilled in the art that various modifications and variations can be made in the present disclosure without departing from the spirit or scope of the present disclosure. Thus, it is intended that the present disclosure cover the modifications and variations of this present disclosure provided they come within the scope of the appended claims and their equivalents.

Any reference in this specification to “one embodiment,” “an embodiment,” “example embodiment,” etc., means that a particular feature, structure, or characteristic described in connection with the embodiment is included in at least one embodiment of the disclosure. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A backlight unit comprising:
N light guide panels arranged in a first direction, N being at least 2, a light guide panel having a light incident section to receive light from the first direction and a light emitting section adjacent to the light incident section to emit light received from the light incident section in a second direction, the first and second directions being different directions; and
a plurality of light sources, the incident section of the light guide panel being adjacent to at least one light source, wherein
a portion of the light emitting section of a K^{th} (K is one of 1 to N−1) light guide panel overlaps a portion of the light incident section of a K+1^{th} light guide panel, and
the light emitting section of the K^{th} light guide panel is spaced a first distance from the light emitting section of the K+1^{th} light guide panel.

2. The backlight unit of claim 1, wherein the first distance corresponds to a gap and substantially no discontinuity of light on a display device is visible.

3. The backlight unit of claim 1, wherein the first distance corresponds to a gap that produces a substantially uniform display brightness including at boundaries between the Kth and Kth+1 light guide panels.

4. The backlight unit of claim 1, wherein the light emitting section of the light guide panel includes a section that decreases in thickness from a first point to a second point, wherein the first point is closer to the light incident section than the second point.

5. The backlight unit of claim 1, further comprising M (M is 2 or greater) light guide panels arranged in the second direction, wherein the light emitting section of an L^{th} light guide panel (L is one of 1 to M−1) of the M light guide panels is spaced a second distance from the light emitting section of an L+1^{th} light guide panel.

6. The backlight unit of claim 1, wherein the first distance ranges from about 0.1 to 5.0 mm.

7. The backlight unit of claim 1, wherein the first distance ranges from about 0.3 to 2.5 mm.

8. The backlight unit of claim 5, wherein the second distance ranges from about 0.1 to 7.0 mm.

9. The backlight unit of claim 5, wherein the second distance ranges from about 0.3 to 2.5 mm.

10. The backlight unit of claim 5, wherein the second distance is greater than the first distance.

11. The backlight unit of claim 5, wherein the second distance ranges from the first distance to two times the first distance.

12. A display apparatus having the back light unit of claim 1, wherein the display apparatus further comprises:
a display panel provided over the back light unit; and
a drive unit for supplying drive power to at least one of the display panel or the light sources.

13. The display apparatus of claim 5, wherein the N×M light guide panels are divided into a plurality of division driving areas, wherein the light guide panels in at least one division driving area emit light independently from the light guide panels in at least one other division driving areas such that a brightness of the at least one division driving area is different from brightness of the at least one other division driving areas.

14. A backlight unit comprising:
M light guide panels, M being at least 2, a light guide panel having a light incident section to receive light from the first direction and a light emitting section adjacent to the light incident section to emit light received from the light incident section in a second direction, the first and second directions being different directions and the M light guide panels being arranged in the second direction; and
a plurality of light sources, the incident section of the light guide panel being adjacent to at least one light source, wherein
the light emitting section of an L^{th} light guide panel (L is one of 1 to M−1) of the M light guide panels is spaced a first distance from the light emitting section of an L+1^{th} light guide panel.

15. The backlight unit of claim 14, wherein the first distance is a gap, and no discontinuity of light is visible.

16. The backlight unit of claim 14, wherein the first distance ranges from about 0.1 to 7.0 mm.

17. The back light unit of claim 14, further comprising a plurality of N light guide panels arranged in the first direction, N being at least 2, the light emitting section of the K^{th} light guide panel is spaced a second distance from the light emitting section of the K+1^{th} light guide panel, K being one of 1 to N−1, wherein the first distance is greater than the second distance.

18. The backlight unit of claim 17, wherein the first distance is no greater than two times the second distance.

19. The backlight unit of claim 17, wherein a portion of the light emitting section of the K^{th} light guide panel of the N light guide panels arrayed in the first direction overlaps a portion of the light incident section of the K+1^{th} light guide panel.

20. A display apparatus having the back light unit of claim 17, wherein the display apparatus further comprises:
a display panel provided over the back light unit; and
a drive unit for supplying drive power to at least one of the display panel or the light sources, wherein the N×M light guide panels are divided into a plurality of division driving areas, wherein the light guide panels in at least one division driving area emit light independently from the light guide panels in at least one other division driving areas such that a brightness of the at least one division driving area is different from brightness of the at least one other division driving areas.
